(19) United States
(12) Patent Application Publication
(10) Pub. No.: US 2006/0084738 A1
(43) Pub. Date: Apr. 20, 2006

(54) Fire retardant adhesive concentrate composition with high specific gravity

(76) Inventors: Richard A. Lopez, Dana Point, CA (US); John S. Sepulveda, Corona, CA (US)

Correspondence Address: CHARLES C.H. WU, 98 DISCOVERY, IRVINE, CA, 92618-3105, US

(21) Appl. No.: 10/965,250

(22) Filed: Oct. 14, 2004

(51) Int. Cl. C08K 3/38

(52) U.S. Cl. 524/404

(57) ABSTRACT

Fire-retardant compositions are disclosed, comprising at least a boron-source composition selected from the group consisting of boric acid and the water-soluble salts thereof, a vinyl acetate/ethylene emulsion, ammonium chloride, an urea casein activator resin, and an urea resin hardener for the urea casein activator resin. The composition provides both excellent adhesive characteristics and fire retardant values to the manufactured wood or polymer products Treatment of lumber, plywood, and other wood products with an aqueous solution of the fire-retardant composition protects lumber, plywood, and other wood products from attack by termites, fungi, fire and flame.

### BACKGROUND OF THE INVENTION

1. Field of Invention

The present invention relates generally to a fire-retardant adhesive composition for wood or plastic products and application methods thereof.

2. Description of Related Art

There are a number of properties in natural wood that make it the product of choice for building construction. Its strength, appearance, durability, accessibility and non-corrosive nature make it ideally suited for building supports, framework, decks and trims. However, wood is highly flammable and susceptible to living organisms. It is known that various compounds can be used to treat cellulosic products in order to impart a wood preservative, and flame resistant qualities thereto. The use of wood treated with such compounds came into common usage during World War II, when it was used for the construction of blimp hangars.

Inorganic boron containing compounds impart fungicidal, insecticidal, and fire retardant properties to wood products. Since inorganic boron compounds are readily soluble in water, exposure to atmospheric moisture can cause leaching of the boron compounds. U.S. Pat. No. 5,612,094 (“Shubert”) disclosed that aqueous compositions of boron compounds in and with zinc zirconium salts in which the ZrO₂:B₂O₃ weight ratio ranged from 0.75:1 to about 10:1, provided wood preservative qualities to treated wood, including protection against fire, fungi, and termites. Shubert disclosed that the zirconium borate compositions were resistant to leaching.

Organic compounds are sometimes added to fire-retardant compositions to seal out moisture and contain the active salt ingredient within the structure of the treated material, thereby also raising the threshold temperature at which activation occurs. For example, U.S. Pat. No. 4,461.720 (“Loyvet”) and U.K. Patent Application GB 2,200,363 both disclosed fire retardant compositions containing partially reacted solutions of dicyandiamide, melamine, formaldehyde, and an oxyacid of phosphorus. The Loyvet composition is a guanyl urea based solution in which the guanyl urea to melamine ratio is within the range of 5:1 to 10:1, and the formaldehyde to guanyl urea melamine mixture is within the range 1:1 to 2:1. These references disclosed that these fire retardant solutions provided improved leach resistance over simple urea solutions.

In addition to the above-described problems in the art with conventional fire-retardant adhesive compounds and with the use of manufactured wood products in the industry, additional problems of pest infestation and control has emerged in recent years. A dramatic example of the problem is seen in the influx of Formosan termites which are found in at least California, Hawaii, Florida, and Louisiana. The pests cause major structural damage to wood structures which can significantly compromise the stability of the wood structures. The problem is exacerbated in situations such as fires and earthquakes. Surprisingly, Formosan termites and other varieties of termites were discovered to be a significant factor in the damage caused during the Northridge, Calif. earthquake in 1994. Termites are but one adventitious organism which is deleterious to the strength of wood.

### SUMMARY OF THE INVENTION

The present invention provides a fire retardant adhesive composition, suitable to be used in various manufactured wood products or plastic products. The composition provides not only excellent adhesive characteristics but also fire retardant values.

The invention features a stable, fire-retardant composition comprising at least a boron-source composition selected from the group consisting of boric acid and the water-soluble salts thereof, a vinyl acetate/ethylene emulsion, ammonium chloride, an urea casein activator resin, and an urea resin hardener for the urea casein activator resin.

The boron-source composition can be boric acid or the water-soluble salts of boric acid, including sodium tetraborate decahydrate, sodium tetraborate pentahydrate, sodium octaborate tetrahydrate, sodium metaborates, sodium perborate hydrates, potassium tetraborate, sodium pentaborate, ammonium pentaborate hydrate, and hydrasodium tetraborate, potassium metaborate, any alkali metal borate salt, or combinations of these compounds. Preferably, the boron source composition is disodium octaborate tetrahydrate, which is commercially available from IMC Chemical, Overland Park, Kans. or U.S. Borax, Inc., Valencia, Calif. or Quality Borate Co., Cleveland, Ohio. The boron-source compound is a primary fire retardant, as well as an insecticidal and fungicidal agent. Preferably, disodium octaborate tetrahydrate is in a powder form.

The vinyl acetate/ethylene emulsion can be any carboxylic copolymer made from vinyl acetate and ethylene, typically used as adhesives for multiple purposes including bonding to metals. The vinyl acetate/ethylene emulsion is characterized by a viscosity (@ 78° F.) ranging from 700-1300 cps, a pH ranging from 4.0-5.5, a specific gravity ranging from about 1.05-1.08 (8.7-9.0 lbs.), and a particle size ranging from about 0.1-1.5 microns. The vinyl acetate/ethylene emulsion is cross-linkable, fast to set and self-thickening. The vinyl acetate/ethylene emulsion is preferably ELVACE® #40722 Vinyl Acetate/Ethylene (VAE) emulsion, commercially available from Forbo Adhesives LLC. Preferably, the vinyl acetate/ethylene emulsion is a liquid.

Ammonium chloride (NH₄Cl) is preferably in a powder form. In general, ammonium chloride provides compatibility for all the chemical ingredients in the composition.

The urea casein activator resin can be any liquid urea formaldehyde resin typically used for fire retardant and manufactured wood products such as lumber, wood particle board, oriented strand board, mineral fiber board, modified density board, glu-Lam wood beams, laminated veneer lumber and fire doors, thus impart fire retardant values to the manufactured wood products. The casein resin activator is characterized by a viscosity (@ 78° F.) of about 500 cp, solids percentage of about 62%, a pH of about 8.0, and a specific gravity of about 1.28. Preferably, the urea casein activator resin is #1750 Urea Resin Adhesive of GP.RTM 1967, commercially available from National Casein, Santa Ana, Calif. and Georgia Pacific Resins, Decatur, Ga. and Quality Borate CO., Cleveland, Ohio, respectively.

A number of urea resin hardeners can be used for the urea casein activator resin, depending on the factors of desired pot life, assembly time, ambient temperature, cure time, type of curing press and type of the wood product. Preferably, the urea resin hardener of the urea casein activator resin is HF5 Hardener, commercially available from National Casein, Santa Ana, Calif. The mixing ratio of the urea resin hardener is about 1% to 10% by weight, for a pot life (@ 75° F.) ranging from 1.5-4.0 hours.

Accordingly, the fire-retardant adhesive composition of the present invention can be used to bind the laminate structure of plywood, veneer products and similar laminar wood structures. Moreover, the fire-retardant adhesive composition of the present invention can be used for polymer products.

In a related aspect, the invention features a process of preparing a fire-retardant adhesive composition used for wood or plastic products, comprising mixing a primary fire-retardant agent selected from the group of boric acid and the water-soluble salts thereof, a vinyl acetate/ethylene emulsion, ammonium chloride, and an urea casein activator resin; adding an urea resin hardener for the urea casein activator resin; and mixing until a smooth composition is obtained. Preferably continuous mixing of the fire-retardant composition is provided throughout the process. Preferably, the fire-retardant composition is mixed without water.

The fire retardant composition can also be used as a concentrate for preparing a fire-retardant preservative composition by adding water into the concentrate. The aqueous composition can be used to treat manufactured wood products for imparting fire-retardant properties. Also the aqueous composition increases the structural strength of the treated wood products, is not corrosive to ordinary metal fasteners such as nails, screws, etc., provides moisture resistant properties to the manufactured wood products, and does not attract adventitious organisms. The aqueous preservative composition of the present invention is also easy to handle because it is a stable aqueous solution, allowing it to be stored and shipped as a solution.

The present invention provides a method for treating flammable wood, wood products or cellulosic materials, such as those used in the construction industry, with an aqueous fire-retardant preservative composition for imparting fire retardant, insecticidal, and fungicidal properties to the manufactured wood products.

Thus, in a further aspect, the invention features a method for manufactured wood products to impart fire, insect, and fungus resistance qualities. The method includes the steps of applying the stable aqueous preservative composition to a wood product. The wood product can be any cellulosic-containing material, such as wood, lumber, wood substrates, paper, plywood, wood particle board, loose fill or panels, oriented strand board, mineral fiber board, modified density overlay, or cellulosic insulation, including loose fill or panel type applications, etc.

The compositions and treatments of the present invention provide superior adhesion abilities along with fire retardant pest control and/or fungus control. Further objects, features and other advantages of the present invention will become apparent from the ensuing detailed description and from the claims.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

### DESCRIPTION OF THE PREFERRED EMBODIMENTS

The present invention provides a fire retardant composition, suitable to be used in various manufactured wood or polymer products. The composition provides not only excellent adhesive characteristics but also fire retardant values.

The fire-retardant compositions of this invention are prepared by mixing the vinyl acetate/ethylene emulsion, ammonium chloride, one or more of the boron source compositions, the urea casein activator resin and the urea resin hardener homogeneously. Thus, the vinyl acetate/ethylene emulsion, ammonium chloride and the boron source compositions can first be mixed together and then can be mixed with the urea casein activator resin. However, mixing is not limited to that order. Next, the urea resin hardener is added to the mixture. This hardener added to the composition acts as a catalyst for the urea casein activator resin. Generally, the urea resin hardener is added last. If a lower percentage of the hardener is added, the composition is less viscous and curing of the composition is slower.

The boron-source composition is a primary fire retardant, as well as an insecticidal and fungicidal agent. The boron-source composition can be boric acid or the water-soluble salts of boric acid. Generally, however, the preservatives may be any hydrate of an alkali metal salt or boric acid. Such salts may include sodium, potassium, lithium, and the like. Compositions having mono-, di-, tri, or other plural salt moieties are contemplated. Similarly, varying degrees of hydration are also contemplated.

Specific compositions include sodium tetraborate decahydrate, sodium tetraborate pentahydrate, sodium octaborate tetrahydrate, sodium metaborates, sodium perborate hydrates, potassium tetraborate, sodium pentaborate, ammonium pentaborate hydrate, and hydrasodium tetraborate, potassium metaborate, any alkali metal borate salt, or combinations of these compounds. Various mixtures of the boron source compositions can also serve as the primary fire retardant. Most preferably, the boron source compound is disodium octaborate tetrahydrate Na₂B₈O₁₃ □ 4H₂O, which is commercially available from sources such as IMC Chemical, Overland Park, Kans. or U.S. Borax, Inc., Valencia, Calif. or Quality Borate Co., Cleveland, Ohio. It is toxic to fungus and wood-destroying insects, including termites. Disodium octaborate tetrahydrate forms finer crystals which more readily penetrate the pores of the porous cellulosic materials to which the compositions are applied. This material also has a high heat activation. In other words, high temperatures are required to convert the disodium octaborate tetrahydrate into the acidic forms in resulting in the fire-retardant effect.

Typically, disodium octaborate tetrahydrate contains about 14.2-15% Na₂O, 67.3-67.5% B₂O₃ and 17.5-17.6% water of crystallization. The boron-source composition is included in the composition in a range of from about 1% to about 10% by weight of the total composition or more preferably from about 4% to about 5%.

The vinyl acetate/ethylene emulsion can be any carboxylic copolymer made from vinyl acetate and ethylene, typically used as adhesives for multiple purposes including bonding to metals. The vinyl acetate/ethylene emulsion is characterized by a viscosity (@ 78° F.) ranging from 700-1300 cps, a pH ranging from 4.0-5.5, a specific gravity ranging from about 1.05-1.08 (8.7-9.0 lbs.), and a particle size ranging from about 0.1-1.5 microns. The vinyl acetate/ethylene emulsion is cross-linkable, fast to set and self-thickening. The vinyl acetate/ethylene emulsion is preferably ELVACE® #40722 Vinyl Acetate/Ethylene (VAE) emulsion, commercially available from Forbo Adhesives LLC, NC. Preferably, the vinyl acetate/ethylene emulsion is a liquid.

The vinyl acetate/ethylene emulsion is included in the composition in a range from about 10% to about 20% by weight of the total composition, preferably about 15% to about 20%. The ratio of the boron-source composition to the vinyl acetate/ethylene emulsion ranges from about 3:0.5, preferably about 4:1.

The use of a vinyl acetate/ethylene emulsion provides the composition of superior adhesive characteristics. The vinyl acetate/ethylene emulsion also increases viscosity of the composition. Thus, the composition of the present invention can offer the treated wood products or materials good adhesion toward other materials, including metals.

Ammonium chloride (NH₄Cl) is preferably in powder forms. In general, ammonium chloride provides compatibility for all the chemical ingredients in the composition. Ammonium chloride can be commercially available from Polarchem Corp., Garden Grove, Calif., catalog #12125-02-9, with a purity of 99.0% higher. Ammonium chloride is also a flame suppressant.

The urea casein activator resin can be any liquid urea formaldehyde resin typically used for marine or N graded plywood. The casein resin activator is characterized by a viscosity (@ 78° F.) of about 500 cp, solids percentage of about 65% -85%, a pH of about 5.5-8.5, and a specific gravity of about 1.35-1.45. The urea casein activator resin is nitrogen-liberating compound, which releases nitrogen in the presence of a flame. Preferably, the urea casein activator resin is #1750 Urea Resin Adhesive or GP.RTM. 1967, commercially available from National Casein, Santa Ana, Calif. and Georgia Pacific Resins, Decatur, Ga., respectively. Preferably, the urea casein activator resin is a liquid.

The urea casein activator resin ranges in an amount of from about 70% to about 80% by weight of the composition. Preferably, the urea casein activator resin is added within the weight ratio range of 4:1 in relation to the VAE emulsion in order to allow for adequate shelf life of the fire-retardant adhesive composition while still allowing for practicable manufacturing times and conditions.

A number of urea resin hardeners can be used for the urea casein activator resin, depending on the factors of desired pot life, assembly time, ambient temperature, cure time, type of curing press and type of the wood product. Preferably, the urea resin hardener of the urea casein activator resin is HF5 Hardener, commercially available from National Casein, Santa Ana, Calif. The mixing ratio of the urea resin hardener is about 1% to 10% by weight, preferably 5% to 7% by weight, for a pot life (@ 75° F.) ranging from 1.5-4.0 hours, for example.

The urea resin hardener acts as a catalyst for the urea casein activator resin. Usually, a lower percentage of the urea resin hardener will activate the urea casein activator resin more slowly, thus allowing a longer manufacturing process for a coating type application.

In formulating the fire-retardant composition of the present invention, the specific gravity ranges from 1.35-1.45, for example. The fire-retardant composition of the present invention is characterized by a formula by weight percent relating the specific gravity, ambient temperature, and percent solids of the fire-retardant adhesive composition.

In a highly preferred embodiment, the fire-preservative composition is prepared according to the following weight percentages (without using water):

| | | |
|---|---|---|
| (1) | Urea Casein Activator Resin (#1750 Urea | 75.83% |
| | Resin Adhesive): | |
| (1A) | Casco-Resin UF BC44 | |
| (2) | Ammonium Chloride (NH₄Cl, preferably in | 0.48% |
| | powder form): | |
| (3) | Disodium Octaborate Tetrahydrate: | 4.73% |
| | (Na₂B₈O₁₃□4H₂O, preferably in powder form) | |
| (4) | VAE Carboxylic Emulsion (ELVACE ® #40722 | 18.96% |
| | VAE emulsion): | |

Then, adding a mixture comprising the urea resin hardener, prepared as follows:

Mixture A: 90% of a mixture of urea casein activator resin, VAE carboxylic emulsion and ammonium chloride+10% of a mixture of disodium octaborate tetrahydrate and a urea resin hardener urea casein (preferably HF5).

Mixture B: 93% of a mixture of urea casein activator resin, VAE carboxylic emulsion and ammonium chloride+7% of a mixture of disodium octaborate tetrahydrate and a urea resin hardener (preferably HF5) Borden Chemical Co. 36-250D (FR3600).

That is, a pre-determined amount of either mixture A or mixture B is added to the combination of (1), (2), (3) and (4), according to the desired percentage of the urea resin hardener.

This mixing ratio can achieve good consistency and appropriate viscosity in the resulting composition.

Accordingly, the fire-retardant adhesive composition can be used to bind the manufactured wood products, including lumber, plywood, wood particle board, oriented strand board, mineral fiber board, modified density board, glu-Lam wood beams, laminated veneer lumber and fire doors, thus impart fire retardant values to the manufactured wood products. Moreover, he fire-retardant adhesive composition can be used for plastic products and imparting fire retardant properties to the polymer products.

As will be appreciated by those in the art, other VAE resin and urea resin systems could be used in accordance with the invention. The basic consideration applicable to the resin systems is that they (i) provide good adhesion functions to the treated wood or polymer products, (ii) add the fire-retardant qualities to the treated wood or polymer products, and (iii) provide wood preservative qualities, to the fire-retardant adhesive composition.

The application method of the fire-retardant composition can be performed in any conventional manner which are well known in the adhesive and fire retardant arts. For example, the application method is a coating type of process, including spraying, brushing or, roll coating etc.

In a related aspect, the fire retardant composition of the present invention can also be used as a concentrate for preparing an aqueous preservative composition by adding water into the concentrate.

By adjusting the amount of water added to the concentrate fire-retardant composition, an aqueous solution (i.e. the aqueous preservative composition) can be prepared, characterized by a specific gravity ranging from 1.35-1.45, a percent solids ranging from 65%-85% and a pH ranging from 5.5-8.5.

The aqueous preservative composition can be used to treat manufactured wood products, including lumber, plywood, wood particle board, oriented strand board, mineral fiber board, modified density board, glu-Lam wood beams, laminated veneer lumber and fire doors, thus impart fire retardant values to the manufactured wood products. The aqueous preservative composition increases the structural strength of the treated wood products, is not corrosive to ordinary metal fasteners such as nails, screws, etc., provides moisture resistant properties to the treated wood products, and does not attract adventitious organisms. The preservative composition of the present invention is also easy to handle because it is a stable aqueous solution, allowing it to be stored and shipped as a solution. Additionally, the preservative composition can be absorbed easily by wood, indicating deeper and more effective wood preservative penetration. Conventional additives can also be added to the preservative composition, such as coloring agents or odor modifying agents, depending upon the wood treatment application.

As will be appreciated by those of ordinary skill in the art, other wood preservatives, fire retardants, insecticidal agents, or fungicidal agents can also be admixed with the preservative composition in accordance with the invention to obtain a similar preservative effect.

The present invention provides a method for treating flammable wood, wood products or cellulosic materials, such as those used in the construction industry, with an aqueous preservative composition for imparting fire retardant, insecticidal, and fungicidal properties to the fire retardant manufactured wood products.

Fire retardant adhesive maintains the structural integrity of the fire retardant manufactured wood product.

The preservative compositions can be applied to any flammable material to decrease flammability. For example, the compositions can be applied to porous materials, including cellulosic products such as paper, wood, lumber, plywood, wood particle board oriented strand board, mineral fiber board, modified density overlay, wood substrates, cellulose insulation including loose fiber or panel-type. The compositions can be applied in any conventional manner which are well known in the wood preserving and fire retardant arts, including soaking, spraying, brushing, rolling, surface application, by adding the composition during manufacture and the like. The preservative compositions can be applied to existing wood or structural members during retrofit or renovation projects in which the wood must be treated in place. In practicing the method of this invention, the wood product is treated with the preservative composition in a manner so as to impregnate the wood product and deposit and distribute a fire retardant, insecticidal, and fungicidal amount of the wood preservative to the wood product being treated. In order to recover excess preservative composition after the wood products have been manufactured, the materials can optionally be brought to a recovery area where excess composition is allowed to drip off the materials and is collected for reuse.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

TEST PROCEDURES: UL 94 Standard for Safety Tests for Flammability of Materials

SIGNIFICANCE: UL 94 testing is applicable to polymeric materials and yield results that show the ability of the material to sustain a flame. Typical plastic materials are rated UL94HB with a horizontal burn rate of less than 40 mm/minute. Fire retardant materials can obtain a UL94V-0 rating if they will not support combustion. A UL94V is run on non-flammable materials.

RESULTS: The material is non-flammable. Vertical testing was performed. Results are shown in table 1, attached.

CONCLUSION: The Lamitek FR3800 material successfully passed UL testing requirements for a rating of UL94V-0 . . . COMPLIES.

TEST PROCEDURES: UL 94 Standard for Safety Tests for Flammability of Plastic Materials

SIGNIFICANCE: UL 94 testing is applicable to polymeric materials and yield results that show the ability of the material to sustain a flame. Typical plastic materials are rated UL94HB with a horizontal burn rate of less than 40 mm/minute. Fire retardant materials can obtain a UL94V-0 rating if they will not support combustion. A UL94 HB test is run first to determine the flammability characteristics. UL94V is run on non-flammable materials.

RESULTS: Results are shown in tables 1-2, attached.

CONCLUSION: The Lamitek FR3800 Material successfully passed UL testing requirements for a rating of UL94V-0 . . . COMPLIES.

PREPARATION: Wood particles were slowly added to premixed adhesive using customer supplied formula dated Sep. 14, 2004. Sample was molded at in a 0.125″×7″ square mold in accordance with customer's procedure dated Sep. 14, 2004.

TEST PROCEDURES: UL 94 Standard for Safety Tests for Flammability of Plastic Materials

SIGNIFICANCE: UL 94 testing is applicable to polymeric materials and yield results that show the ability of the material to sustain a flame. Fire retardant materials can obtain a UL94V-0 rating if they will not support combustion. UL94V is run on non-flammable materials.

RESULTS: Results are shown in table 1, attached.

CONCLUSION: The Lamitek FR Particle Board successfully passed UL testing requirements for a rating of UL94V-0 . . . COMPLIES.

What is claimed is:

1. An fire-retardant adhesive composition for wood products, consisting essentially of a mixture of a boron source composition selected from the group of boric acid and the water-soluble salts thereof, a vinyl acetate/ethylene emulsion, ammonium chloride, a urea casein activator resin and an urea resin hardener.

2. The composition of claim 1, wherein the boron source composition is in an amount of at least about 4% to about 5%, the percentage of the urea casein activator resin in the fire-retardant adhesive composition ranges from about 70% to about 80%, and the percentage of the vinyl acetate/ethylene emulsion in the fire-retardant adhesive composition ranges from about 10% to about 20%.

3. The composition of claim 1, wherein the boron source composition is in an amount of at least about 4% to about 5%, the vinyl acetate/ethylene emulsion is in an amount of at least 15% to about 20%, and the urea casein activator resin is in an amount of at least about 73% to about 78%, by weight.

4. The composition of claim 3, wherein ammonium chloride is in an amount of at least about 0.4% to about 0.5% by weight.

5. The composition of claim 1, wherein the urea resin hardener is in an amount of about 1% to about 10% by weight.

6. The composition of claim 3, wherein the urea resin hardener is in an amount of about 5% to about 7% by weight.

7. The composition of claim 1, wherein the boron source composition is disodium octaborate tetrahydrate.

8. The composition of claim 3, wherein the composition has a specific gravity of about 1.20 to about 1.24.

9. The composition of claim 3, wherein the composition has a specific gravity of about 1.35 to about 1.45.

10. A stable, aqueous preservative composition for treating a wood product, consisting essentially an aqueous solution of a fire retardant composition consisting essentially of a boron source composition selected from the group of boron acid and the water-soluble salts thereof, a vinyl acetate/ethylene emulsion, ammonium chloride, a urea casein activator resin and an urea resin hardener.

11. The preservative composition of claim 10, wherein the boron source composition is disodium octaborate tetrahydrate.

12. The preservative composition of claim 10, wherein the boron source composition is in an amount of at least about 4% to about 5%, the percentage of the urea casein activator resin in the fire-retardant adhesive composition ranges from about 70% to about 80%, and the percentage of the vinyl acetate/ethylene emulsion in the fire-retardant adhesive composition ranges from about 10% to about 20%.

13. The composition of claim 11, wherein the boron source composition is in an amount of at least about 4% to about 5%, the vinyl acetate/ethylene emulsion is in an amount of at least 15% to about 20%, and the urea casein activator resin is in an amount of at least about 73% to about 78%, by weight.

14. The composition of claim 13, wherein ammonium chloride is in an amount of at least about 0.4% to about 0.5% by weight.

15. The composition of claim 10, wherein the urea resin hardener is in an amount of about 1% to about 10% by weight.

16. The composition of claim 13, wherein the urea resin hardener is in an amount of about 5% to about 7% by weight.

17. A method for preserving a wood product against fungus, insects and fire, comprising the steps of manufacturing the wood product with a fungicidal, insecticidal, and fire retardant amount of a stable, aqueous preservative composition, wherein the aqueous preservative composition consisting essentially of a boron source composition selected from the group of boron acid and the water-soluble salts thereof, a vinyl acetate/ethylene emulsion, ammonium chloride, a urea casein activator resin and an urea resin hardener; and curing the manufactured wood product until the hygroscopic moisture content is at or below about 19%.

18. The method of claim 17, wherein the boron source composition is disodium octaborate tetrahydrate.

19. The method of claim 17, wherein the manufactured wood product is cured at temperatures between 200° F.-392° F.

20. The method of claim 17, wherein the treated wood product is selected from the group of lumber, plywood, wood particle board, oriented strand board, mineral fiber board, and modified density overlay.
